(19) United States
(12) Patent Application Publication
(10) Pub. No.: US 2009/0047388 A1
(43) Pub. Date: Feb. 19, 2009

(54) CALCIUM FORTIFIED CREAMED HONEY

(76) Inventors: Salmon L. Wright, IV, Lafayette, LA (US); Salmon L. Wright, III, Crowley, LA (US); Darry L. Holliday, Crowley, LA (US); Kenneth L. Venable, Crowley, LA (US)

Correspondence Address: KEAN, MILLER, HAWTHORNE, D'ARMOND,;MCCOWAN & JARMAN, L.L.P., ONE AMERICAN PLACE, 22ND FLOOR, P.O. BOX 3513, BATON ROUGE, LA, 70821, US

(21) Appl. No.: 11/839,368

(22) Filed: Aug. 15, 2007

(51) Int. Cl. A23L 1/303; A23D 7/00; A23L 1/0532; A23L 1/0562; A23L 1/48; A23L 1/08; A23L 1/20; A23L 1/302

(52) U.S. Cl. 426/73; 426/541; 426/575; 426/576; 426/613; 426/634; 426/645; 426/72

(57) ABSTRACT

A calcium fortified creamed honey product. An effective amount of calcium mineral having a mean particle size of about 30 nanometers to about 10 microns is added to the honey to provide not only calcium fortification but also to provide creamed honey with a smooth texture for enhanced spreadability.

### FIELD OF THE INVENTION

The present invention relates to a calcium fortified creamed honey product. An effective amount of calcium mineral having a mean particle size of about 30 nanometers to about 10 microns is added to the honey to provide not only calcium fortification but also to provide creamed honey with a smooth texture for enhanced spreadability.

### BACKGROUND OF THE INVENTION

Calcium is one of the most abundant elements on earth, and it is the most abundant mineral in the human body. It has many important roles such as signaling biochemical processes in cells, controlling muscle contractions, initiating DNA synthesis, and building bones. The skeletal system houses 99% of the body's calcium and the other 1% circulates in the blood stream. Calcium maintains the integrity of the skeletal system, providing strength and structure to the bones and teeth. It plays a crucial role in coagulation of blood, generation and transmission of nerve impulses, the contraction of muscle fibers, and the activization of various enzymes and release of some hormones that regulate digestion and metabolism. It is also essential for wound healing and maintenance of cell membranes. Most adults get only half the amount of calcium they need daily. Thus, large segments of the U.S. population fall short of meeting calcium recommendations. Further, persons over the age of 70 have unique calorie and nutrient needs. Recently, a new Modified Food Guide Pyramid for 70+ yr. adults has been developed. It recommends eating at least three servings of calcium-rich foods to meet the daily requirements of calcium and Vitamin D.

As previously mentioned, 99% of a person's body's calcium is stored in bones and teeth. This calcium makes up a person's bone bank. Calcium is “deposited” and “withdrawn” from the bone bank daily, based on the body's need for calcium. If one's daily diet is low in calcium, calcium is “withdrawn” from the bone bank. Bone is broken down to keep one's blood calcium level normal. This happens because calcium plays a critical role in supporting the body's vital functions; such as controlling blood pressure. Also, a low blood calcium level can result in kidney failure and vitamin D deficiency. To promote strong bones throughout life, it is recommended that everyone, including pregnant or breastfeeding women, consume the following daily calcium intakes recommended by the Food and Nutrition Board of Medicine, National Academy of Science and referred to as the Dietary Reference Intake (DRI):

| Age (years) | Ca (mg/day) |
|---|---|
| 1-3 | 500 mg |
| 4-8 | 800 mg |
| 9-18 | 1300 mg |
| 19-50 | 1000 mg |
| 51 or older | 1200 mg |

To help provide adequate levels of calcium in the diet, a wide variety of calcium-fortified foods and beverages are being marketed. One particularly beneficial food that can be fortified to deliver calcium to consumers is honey. Honey is the world's oldest sweetener and was the major sweetener until sugar cane was cultivated on a large scale. Honey is often eaten as an energy food. Its simple sugars are absorbed directly into the bloodstream without digestion. Honey mixes well as a sweetener in hot and cold drinks. It goes with nearly all foods, from salad dressings to vegetable and meat glazes to casserole dishes. It is especially good in desserts and baked goods. Also, the moisture-absorbing quality of honey helps breads, cakes, cookies and candies stay fresh longer.

Honey differs widely in its chemical composition depending on the plant source and on the bee which converts the nectar to honey, but it is comprised primarily of carbohydrates and water and typically contains from about 13 to 23 wt. % water, about 23 to 44 wt. % fructose, about 23 to 41 wt. % glucose (dextrose), about 0.2 to 8 wt. % sucrose, and about 3 to 24 wt. % other sugars. Honey also contains small amounts of a wide variety of vitamins and minerals, including niacin, riboflavin, calcium, iron, magnesium, manganese, phosphorus, potassium and zinc. Honey also contains a variety of flavonoids and phenolic acids that act as antioxidants, scavenging and eliminating free radicals. There are also medicinal benefits attributed to honey. For example, honey can help heal small skin wounds and honey can help reduce scarring.

Honey has several negative attributes associated with its use. Two major negative attributes of honey are handling problems and its natural affinity to return to a crystallized state. Natural honey tends to crystallize and become somewhat granular in consistency upon exposure to sunlight and relatively cold temperatures. In this form, the honey loses its value as a food-stuff because it cannot be easily spread onto foods such as bread, crackers, pancakes, and the like. Granulated honey can be liquefied by heating, but when applied to other foodstuffs, the liquefied honey tends to “run” or drip off the foodstuff to which it is applied. The extent of this granulation is known to be related to glucose (dextrose hydrate) supersaturation.

Attempts have been made to overcome the crystallation problem by creaming the honey using the so-called Dyce method. The Dyce method requires seed nuclei to be added to the honey to promote controlled crystallation. However, creamed honey formed using this method is not very convenient to use because of its stickiness. Moreover, the creamed honey formed using this method still possesses the intense sweetness of pure honey. U.S. Pat. No. 4,973,491 teaches a method for forming a honey product that is readily sliced into individual portions, which product is produced by mixing honey with an effective amount of an oil-rich nut product such as peanut meal or peanut flour.

U.S. Pat. No. 4,532,143 teaches a spreadable honey product comprised of honey and pectin wherein the pectin is comprised of a mixture of low-methoxy pectin and high-methoxy pectin. Also, a whipped honey spread is taught in U.S. Pat. No. 4,004,040 wherein a liquefied, unpasteurized natural honey is introduced into a closed chamber and subjected to shearing and agitation at a temperature from about 50° F. to about 60° F. at superatmospheric pressure for a sufficient amount of time to incorporate and uniformly distribute minute bubbles of gas throughout the honey.

While various processes have been disclosed in the art for preparing whipped, or creamed honey, there still exists a need in the art for improved processes, especially those that are able to simultaneously provide fortification as well as a processing aid for the production of the creamed honey end product.

### SUMMARY OF THE INVENTION

In accordance with the present invention there is provided a creamed honey product comprised of honey and an effective amount of particles of calcium salt which particles have a mean particle size in the range of about 30 nanometers to about 10 microns.

In a preferred embodiment there is also provided a method for preparing a calcium fortified creamed honey product, which method comprising blending an effective amount of particular calcium salt having a mean particle size in the range of about 30 nanometers to about 5 microns.

In another preferred embodiment of the present invention the calcium salt is selected from the group consisting of calcium carbonate, calcium phosphate, e.g., calcium monophate, calcium diphosphate, calcium triphosphate, calcium ascorbate, calcium chloride, calcium citrate, calcium gluconate, calcium glycerophosphate, calcium maleate, calcium hydrogen maleate, calcium lactate, calcium oxide, and the like.

### DETAILED DESCRIPTION OF THE INVENTION

Fortification of highly viscous liquids, such as honey, is difficult because honey has a relatively low amount of water, i.e., from about 13 to 23 wt. %. Thus, it is difficult for honey to achieve a level of calcium at concentrations of 10% or more of the RDI since very little honey is used per serving. For example, only a small amount of honey is added as a sweetener for baked goods or used as a spread for bread or toast in the form of creamed honey. However, one objective of the present invention is for a honey to contain at least about 10% of the RDI of calcium per serving, and more preferably from about 10% to about 70% of the RDI of calcium per serving, and even more preferably from about 10% to about 40% of calcium per serving and most preferably from about 20% to about 30% of the RDI of calcium per serving size.

Serving as used herein is a term of art, but varies with the type of product or its use. The Nutrition Labeling and Education Act of 1990 standardized the serving size of honey to be one tablespoon. Thus, unless indicated to the contrary, as used herein, the serving size is 1 tablespoon. It is preferred that the honey of the present invention contain from about 100 mg to about 700 mg of calcium per tablespoon, and more preferably from about 200 mg to about 500 mg calcium per tablespoon, and most preferably from about 200 mg to 400 mg calcium per tablespoon.

Calcium, especially in the form of a water soluble salt, can add a bitter flavor to many food products, necessitating the use of flavors to mask calcium fortification. The present invention is capable of fortifying honey with a form of calcium that is substantially flavor neutral. For example, the honey of the present invention has a distinct pleasant aftertaste with substantially no gritty mouth-feel. Thus, it is not necessary to include a flavor mask. However, optionally, if one desires, a flavoring agent may be added to the honey, as described hereinbelow.

The present inventors have found that if the use of a calcium source, i.e., calcium salts, significantly reduced in size into a fine powder having particles ranging from nano-size to micron-size will mitigate several problems. Such problems include aftertaste and gritty mouth-feel. Both of these problems are solved, by the practice of the present invention, as well as providing a creamed honey product that is exceptionally smooth and is easier to spread when compared to creamed honey made by other conventional methods. Creamed honey, which is also sometimes referred to as “whipped honey” is a honey that is brought to market in a granulated state. Although liquid honey will eventually crystallize, creamed honey is made wherein the crystallizationed is controlled so that at refrigerated temperature the creamed honey can be spread like butter. In fact, in many countries creamed honey is preferred to liquid honey.

The calcium salt is reduced to a size having a mean diameter of about 30 nanometers to about 10 microns in size, more preferably from about 40 to about 5 microns, and most preferably from about 100 nanometers to about 2 microns. By reducing the size of the particles of the calcium salt, the inventors have found that more calcium can be suspended in the honey, and its consistency and smoothness, as well as shelf life is improved. The calcium salts can be subjected to any techniques known in the art that reduces the size of the particles size of 30 nanometers to 10 microns. The use of calcium salt in this fine particle size range in the honey retards the rate that the calcium salt will precipitate, or separate, from the honey.

The source of calcium for providing calcium fortification for the honey of the present invention is preferably a tasteless calcium salt that does not adversely affect flavor or texture of the honey. The honey may contain one or more calcium salts. Non-limiting examples of calcium salts suitable for use in the present invention include calcium carbonate, calcium phosphate, e.g., calcium monophate, calcium diphosphate, calcium triphosphate, calcium ascorbate, calcium chloride, calcium citrate, calcium gluconate, calcium glycerophosphate, calcium maleate, calcium hydrogen maleate, calcium lactate, calcium oxide, and the like. It is preferred that the calcium is present in a salt wherein the relative molar ratio of calcium to the anion per molecule in at least 1:1. Calcium carbonate and calcium phosphate are preferred. Calcium carbonate is the most preferred calcium component for fortification of the honey. For example, in calcium carbonate, CaCO₃, the relative molar ratio of Ca²⁺ to (CO₃)²⁻ is 1:1 while in Ca₃(PO₄)₂, the relative molar ration of Ca²⁺ to (PO₄)³⁻ is 1.5:1. The preferred calcium salts are calcium carbonate and calcium phosphate. Calcium phosphate is generally available as a mono basic salt Ca(H₂PO₄)₂, dibasic salt CaHPO₄ or tribasic salt Ca₃(PO₄)₂. Especially preferred for use herein is tricalcium phosphate, because of its high weight percentage of calcium (about 38%).

The use of the small particle size calcium salt particles of the present invention facilitates the calcium fortification of the honey without imparting a gritty texture thereto and without causing calcium precipitation from the honey. The nano-/micron sized particles of the calcium salt, e.g., tricalcium phosphate, coupled with the viscosity of the honey keep the particles in suspension and substantially uniform in the product. That is, the inventors have discovered that the use of the very small calcium particles keeps the calcium in suspension in a substantially homogeneous manner throughout the honey for an acceptable period of time.

Moreover, the use of the small particle size calcium salts, wherein the calcium is present in at least a 1:1 molar ratio relative to the anion, affords an additional advantage. The Nutrition Labeling and Education Act standardized the serving size of chocolate honey to 1 tablespoon (e.g. about 21 grams). Whereas a beverage such as milk or orange juice has a serving size of 8 fluid ounces or about 275 grams, the serving size of honey according to the Nutrition Labeling Education Act is two tablespoons per serving. However, a consumer may consume more or less than two tablespoons of honey per serving, e.g., on a topping, e.g., on cakes, ice cream, pies, or other foods or in a beverage, e.g., milk, and the like. For example, the consumer may utilize 1, 1.5, 2, 2.5, 3, or more tablespoons of the honey per serving. Thus, the honey of the present invention can be used for any amount per serving. The two tablespoon serving discussed herein is used solely for purposes of standardization. Nevertheless, in two tablespoons, for the honey to have the same amount of calcium in a serving size relative to the serving size of milk or orange juice, the calcium would have to be present in an amount of about 7 times more in a serving of honey versus a serving of milk or orange juice.

The present invention overcomes the small serving size and, therefore, the calcium concentration factor by the use of the small particle size calcium salts. The use of such nano/micronized calcium salts, such as calcium carbonate, as the source of calcium, reduces the amount of fortifying calcium required. For example, calcium carbonate contains almost 40% calcium which is higher than most sources of calcium and almost double that of the calcium maleate. In a preferred embodiment, the calcium fortified honey according to the present invention contains about 5% to 25% by weight of the calcium, more preferably from about 10 to 12% by weight.

It is preferred that an effective amount of an additive selected from suspending agents, emulsifying agents, thickening agents and the like be used in the practice of the present invention. It is more preferred that the additive be a suspending agent to aid in maintaining the uniformity of the composition. The incorporation of suspending or thickening agents helps suspend the calcium and help control viscosity. Examples of suitable suspending or thickening agents that can be utilized in the honey of the present invention include xanthan gum, guar gum, polysaccharides, such as starch, cellulose (e.g., microcrystalline cellulose) and carrageenan, and polyuronides. Gelatin is another example of a suspending agent which may be used in the present honey compositions. Carrageenan is the preferred suspending agent and is preferable in a effective thickening amount. It is preferred that if present, the suspending agent be present in an amount of from about 0.01% to about 0.2%, and preferably 0.01% to about 0.05% by weight of the creamed honey product.

Vitamins, minerals, cholesterol reducing agents, and other nutrients, may additionally be present. For example, Vitamin D, Vitamin E, biotin, panothenic acid or salt thereof, zinc or salt thereof, along with any other nutrient deemed necessary for proper nutrition, following the recommended intakes RDIs, in addition to other ingredients such as soy, plant sterols, anti-oxidants, omega 3-fatty acids, and the like, may be added to the honey of the present invention. In addition, they may be present in the salt form, whenever commercially available. Vitamin D is a preferred additive.

The creamed honey of the present invention is prepared in accordance with conventional methods, except that the desired amount of calcium salt with the desired particle size is added thereto. Although the honey may be prepared by either a continuous or batch process, it is preferred that it is prepared by a batch process. The calcium salt can be added at any stage of the process, but preferably the calcium salt is added at the beginning of the process.

Typical extracted honey has a solids content from about 79% to about 85% and a water content from about 15% to about 21%, the contents of solids and water being based on the total weight of the honey. For the purpose of this invention, honey as referred to herein shall include both water and solids. In forming the honey product of the present invention, it is preferred to use honey having solids content from about 80% to about 83% by weight of the honey. As mentioned above, the honey is mixed with the calcium salt to form the honey product in accordance with the present invention. In particular, to form the honey product in accordance with the present invention, honey is initially pasteurized at about 80° C. for an effective amount of time, typically from about 5 to about 15 minutes, then cooled to about 100° C. The selected calcium salt or salts is incorporated into the honey using a colloid mill and mixed thoroughly to ensure even particle distribution. During this process, the moisture level is maintained at about 3% to about 5% by weight of the mixture by adding water when required and by controlling the time and temperature during processing. The blended honey product is then poured into suitable containers which are subsequently covered to prevent moisture loss and stored in refrigerated temperatures until granulated and then moved to ambient temperatures and stored for shipping to market.

The present invention is explained in greater detail by reference to the following examples, but the present invention should not be construed as limited thereto. The invention will now be further illustrated by the following examples.

The following experiments were conducted in order to determine the ideal particle size for seeding the honey, various average particle sizes as set forth in Table 1 below of “seed” mixtures were tested for their effect on honey granulation.

### EXAMPLES

TABLE 1
Material and Particle Size

| | Average Particle Size |
|---|---|
| Material | (microns) |
| Calcium Carbonate, precipitated | 0.7 |
| Calcium Carbonate/Vitamin D3/Carrageenan | 0.8985 |
| Calcium Carbonate, extra fine | 2.0 |
| Calcium Carbonate, fine | 7.0 |
| Calcium Phosphate, monohydrate | 44 |
| Calcium Citrate, malate | 250 |

Each experiment was performed by blending together 30.2 grams of each calcium source with 500 grams of honey. The blend was mixed in a 6 quart Kitchenaid mixer bowl with paddle for 5 minutes (or until a substantially homogeneous blend). Each sample was then set in a refrigerator at 38° F. for 12 hours. The samples were removed, tested, and then allowed to rest at room temperature for 3 hours before testing again.

The resulting product was tested for mouthfeel (texture) and flavor. Flavor and texture were measured by using a sensory panel to determine whether or not the finished honey spread had an off- or unpleasant taste compared to what was expected for the honey spread. The results are shown in Table 2 and 3 below.

TABLE 2
Material, Texture, and Flavor Results (refrigerated)

| Material | Texture | Flavor |
|---|---|---|
| Calcium Carbonate, precipitated | Very creamy | Very sweet, Honey flavor |
| Calcium Carbonate/Vitamin D3/Carrageenan | Very creamy | Sweet, Strong honey flavor |
| Calcium Carbonate, extra fine | Creamy | Sweet, Strong honey flavor |
| Calcium Carbonate, fine | Slightly gritty | Sweet, Honey flavor, Slight off-flavor |
| Calcium Phosphate, monohydrate | Grainy | Semi-sweet, Slight honey flavor, Chalky |
| Calcium Citrate, malate | Very Grainy | Semi-sweet, Slight honey flavor, Chalky |

TABLE 3
Material, Texture, and Flavor Results (room temperature)

| Material | Texture | Flavor |
|---|---|---|
| Calcium Carbonate, precipitated | Very smooth | Very sweet, Honey flavor |
| Calcium Carbonate/Vitamin D3/Carrageenan | Very smooth | Sweet, Strong honey flavor |
| Calcium Carbonate, extra fine | Smooth | Sweet, Strong honey flavor |
| Calcium Carbonate, fine | Slightly gritty | Sweet, Honey flavor, Slight off-flavor |
| Calcium Phosphate, monohydrate | Grainy | Semi-sweet, Slight honey flavor, Chalky |
| Calcium Citrate, malate | Very Grainy | Semi-sweet, Slight honey flavor, Chalky |

Starting with the larger seed particles, it was observed that as the particle sizes increased above 5 microns the products took on a gritty mouthfeel and the texture was grainy. Therefore, particle sizes greater than about 5 microns create larger glucose crystals as the honey granulates which results in an indesirable gritty honey spread.

The samples that were prepared using “seed” mixtures in the range of 5 microns to 30 nanometers had a smooth, creamy texture, with no off-flavor, and they appeared to be homogenous mixtures. Therefore, this size range appears to be ideal when creating a creamed honey spread.

The use of an additive such as carrageenan increased the smoothness of the product and helped the calcium stay suspended in the honey after blending.

What is claimed is:

1. A creamed honey product comprised of honey and an effective amount of particles of a calcium salt which particles have a mean diameter in the range of about 30 nanometers to about 10 microns and the amount of calcium is from about 100 mg to about 700 mg per tablespoon.

2. The creamed honey product of claim 1 wherein the calcium salt is selected from the group consisting of calcium carbonate, calcium phosphate, e.g., calcium monophate, calcium diphosphate, calcium triphosphate, calcium ascorbate, calcium chloride, calcium citrate, calcium gluconate, calcium glycerophosphate, calcium maleate, calcium hydrogen maleate, calcium lactate, and calcium oxide.

3. The creamed honey product of claim 2 wherein the calcium salt is calcium carbonate.

4. The creamed honey product of claim 2 wherein the amount of calcium is from about 200 mg to about 500 mg per tablespoon.

5. The creamed honey product of claim 1 which also contains an effective amount of an additive selected from the group consisting of suspending agents, emulsifying agents, and thickening agents.

6. The creamed honey product of claim 5 wherein there is present an effective amount of a suspending agent selected from the group consisting of xanthan gum, guar gum, polysaccharides, such as starch, cellulose, gelatin, carrageenan, and polyuronides.

7. The creamed honey product of claim 5 wherein the amount of additive is from about 0.01 to about 0.2% by weight based on the total weight of the creamed honey product.

8. The creamed honey product of claim 6 wherein the suspending agent is carrageenan.

9. The creamed honey product of claim 1 which also contains an effective amount of an additional additive selected from the group consisting of vitamins, minerals, and cholesterol reducing agents.

10. The creamed honey product of claim 9 wherein the additional additive is selected from the group consisting of vitamin D, vitamin E, biotin, panothenic acid and salts thereof, and zinc and salts thereof.

11. The creamed honey product of claim 1 wherein there is also present an effective amount of an ingredient selected from soy, plant sterols, anti-oxidants, and omega 3-fatty acids.
